(19) United States
(12) Patent Application Publication
(10) Pub. No.: US 2008/0075990 A1
(43) Pub. Date: Mar. 27, 2008

(54) FUEL REFORMING APPARATUS AND FUEL CELL SYSTEM

(76) Inventors: Yoshiyuki Isozaki, Tokyo (JP); Hideo Kitamura, Yokohama-shi (JP); Nobuo Shibuya, Hiratsuka-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/686,517

(22) Filed: Mar. 15, 2007

(30) Foreign Application Priority Data
Sep. 27, 2006 (JP) 2006-263423

(51) Int. Cl. H01M 8/06

(52) U.S. Cl. 429/20

(57) ABSTRACT

A fuel reforming apparatus has a reformer for heating and reforming a liquid fuel to produce a hydrogen-containing gas, a combustor for burning hydrogen with an oxidant to obtain a combustion heat used for heating the reformer, a heat insulation container for surrounding the reformer and the combustor, a heat-sensitive switch for conducting switching operations when a temperature of an outer wall of the heat insulation container exceeds a set value, a fuel supply section having a first electrical driving section for receiving feed of an electric current from a power source through the heat-sensitive switch, and supplying the liquid fuel to the reformer during a period in which the temperature is equal to or less than the set value, and an oxidant supply section for supplying the oxidant to the combustor.

### CROSS-REFERENCE TO RELATED APPLICATIONS

This application is based upon and claims the benefit of priority from prior Japanese Patent Application No. 2006-263423, filed Sep. 27, 2006, the entire contents of which are incorporated herein by reference.

### BACKGROUND OF THE INVENTION

1. Field of the Invention

The present invention relates to a fuel reforming apparatus the safety of which is particularly improved, and a fuel cell system provided with the fuel reforming apparatus.

2. Description of the Related Art

In recent years, a variety of electronic devices such as cellular phones, video cameras, and personal computers are downsized with developments in semiconductor technology, and in this connection, further compactness has been demanded. As a power source satisfying such demands, simple and convenient primary or secondary cells have heretofore been used. However, primary or secondary cells involve functionally the limitation of operating time, so that the electronic devices using such electric cells have a limitation with respect to the operating time.

Namely, actual service life is short with respect to the weight of primary cell, whereby frequent exchange of electric cells is required so that such primary cell is unsuitable for portable electronic devices. On the other hand, since a power supply for electric charge is required in secondary cell, the applicable place is limited, and further a considerable time is required for electric charge in the secondary cell. Particularly, it is difficult to exchange an electric cell in an electronic device and the like into which the secondary cell has been previously incorporated, when the electric cell has completely discharged the electricity. Under the circumstances, the operating time of the electronic device is restricted. As described above, it is difficult to satisfy such demands for operating a variety of small items for a long period of time with the use of an electric cell by an extension of conventional primary or secondary cell, and thus, an electric cell suitable for the operation of a longer period of time has been demanded.

As a countermeasure for solving such problems as described above, fuel cell has been attracting attention recently. Fuel cell has advantages not only in achieving power generation by supplying only a fuel and an oxidant, but also in continuous power generation by exchanging only the fuel. Accordingly, it is considered that if fuel cell can be downsized, it is an extremely advantageous system for driving handheld electronic devices.

In a field of general fuel cells, such a fuel cell system obtained by combining a raw material of light hydrocarbons such as natural gas, and naphtha or alcohols such as methanol; a reformer provided with a catalyst for reforming these raw materials; and a fuel cell is developed. Such fuel cell system as described above gives a high output voltage and a high efficiency in comparison with a direct type methanol fuel cell or the like in which a liquid fuel such as methanol is used, so that downsizing and high performance of the fuel cell system are expected.

In the fuel cell system provided with a reformer, a material of hydrocarbons, alcohols, and ethers is used as the fuel. The material is heated to a temperature of from 200° C. to around 400° C. to be allowed to react with water vapor in the reformer, whereby the material can be converted into hydrogen and carbon dioxide. For instance, when methanol is used as the fuel, a temperature inside a reformer housing main body is around 300° C.

Since such reformer is heated at a high temperature as described above, there is a reformer provided with a heat insulation container for thermally insulating the reformer from the environment in order to prevent the heat dissipation to the environment. For example, there is a reformer contained in a vacuum heat insulation container the interior of which has been kept in vacuum.

In the case where a fuel cell system provided with a reformer is used as the power source for handheld electronic devices, a sufficient countermeasure for assuring the safety is desired. For instance, when any impact is applied to a vacuum heat insulation container resulting in any malfunction such as a damage of the vacuum heat insulation structure, there is a fear of a breakage due to overheating of an electronic device as a result of transmitting the heat from the reformer to the environment, or a burn injury of a user. For this reason, it is required to detect rapidly a malfunction such as a damage of the vacuum heat insulation container and to take an adequate procedure therefor.

In JP-A 2004-178910 (KOKAI) (hereinafter referred to as “reference 1”), means for detecting a malfunction (temperature rise) of a fuel cell system provided with a reformer is disclosed. The fuel cell system of the reference 1 is provided with a CPU (Central Processing Unit) serving as a control section, a temperature sensor, and a RAM (Random Access Memory), wherein the fuel cell system detects a temperature of the reformer by means of the temperature sensor. As a result, when the temperature detected is lower than a set value, the control section judges that a malfunction such as a breakage of vacuum heat insulation has occurred in the vacuum heat insulation container, and then, the control section is allowed to notify a possibility of the occurrence of the breakage in the vacuum heat insulation to a notification section. Furthermore, there is such a description in the patent reference 1 that, when the occurrence of malfunction has been detected, the control section outputs a fuel supply control signal to a pump to stop the supply of a fuel, and further outputs a temperature control signal to a heater for heating service to stop the heating operation (energization of electric current) in the heater for heating service.

In JP-A 2003-221206 (KOKAI) (hereinafter referred to as “reference 2”), there is such a description that in a fuel reforming apparatus used for a fuel cell for home use, the exhaust gas exhausted from a reforming section combustor is heat-exchanged with water to produce water vapor, a temperature in the vicinity of the outlet of an evaporator exhausting the exhaust gas after the heat exchange is detected by means of a temperature sensor provided in the vicinity of the outlet, and when the temperature detected exceeds the set value, a controller outputs a system stop command for stopping the system and further outputs a stop signal to a water pump.

In JP-A 11-302001 (KOKAI) (hereinafter referred to as “reference 3”), a CO remover for removing CO from the hydrogen-containing gas produced in a reformer is described. The CO remover is provided with an air feed port to which a bimetal for adjusting an air mass flow is attached, wherein the bimetal narrows the air feed port to reduce an amount of air fed into the CO remover in case of a high temperature, while the bimetal expands the air feed port to increase the amount of air fed into the CO remover in case of a low temperature. Hence, selective oxidative combustion of the CO in the reformed gas is controlled to remove the CO therefrom.

In the fuel cell systems of the references 1 and 2, however, a microcomputer involving a CPU and a RAM is required for comparing the temperature detected by means of the temperature sensor with the set value to judge a result, and controlling the system in response to the result judged. Accordingly, the whole fuel cell system increases in size, and it becomes expensive, so that it is not desirable as a power source for handheld electronic devices. Moreover, there is a possibility of erroneous operations in the microcomputer, so that abnormal operations (overheating operation) due to the erroneous operations cannot be effectively avoided. On the other hand, since only the selective oxidative combustion reaction of the CO in the reformed gas is controlled in the fuel cell system of the reference 3, the system cannot cope with a damage of the heat insulation structure in the reformer which occurs accidentally.

### BRIEF SUMMARY OF THE INVENTION

An object of the present invention is to provide a safe and highly reliable fuel reforming apparatus and a fuel cell system, having a small and simple configuration, which can rapidly cope with an accident such as a breakage of a heat insulation container or a malfunction occurring accidentally.

According to an aspect of the present invention, there is provided a fuel reforming apparatus, comprising: a reformer to reform a liquid fuel to produce a hydrogen-containing gas; a combustor to burn hydrogen with an oxidant to obtain a combustion heat used for heating the reformer; a heat insulation container which surrounds the reformer and the combustor; a heat-sensitive switch which conducts switching operations, when a temperature of an outer wall of the heat insulation container exceeds a set value; a fuel supply section which has a first electrical driving section that receives feed of an electric current from a power source through the heat-sensitive switch, and which supplies the liquid fuel to the reformer during a period in which the temperature is equal to or less than the set value; and an oxidant supply section which supplies the oxidant to the combustor.

According to another aspect of the present invention, there is provided a fuel reforming apparatus, comprising: a reformer to reform a liquid fuel to produce a hydrogen-containing gas; a combustor to burn hydrogen with an oxidant to obtain a combustion heat used for heating the reformer; a heat insulation container which surrounds the reformer and the combustor; a heat-sensitive switch which conducts switching operations when a temperature of an outer wall of the heat insulation container exceeds a set value; an electric current production section which produces electric current turned ON/OFF by switching the operations of the heat-sensitive switch; a fuel supply section which has a first electrical driving section operated by receiving feed of an electric current from the electric current production section, and which supplies the liquid fuel to the reformer during a period in which the temperature is equal to or less than the set value; and an oxidant supply section which supplies the oxidant to the combustor.

Moreover, according to another aspect of the present invention, there is provided a fuel cell system comprising the fuel reforming apparatus in accordance with the first or the second aspect; and a fuel cell unit having a cathode electrode, an anode electrode for receiving the hydrogen-containing gas produced by the reformer, and an electrolyte membrane.

### BRIEF DESCRIPTION OF THE SEVERAL VIEWS OF THE DRAWING

FIG. 1 is a view schematically showing a fuel cell system according to a first embodiment of the present invention;

FIG. 2 is a perspective view schematically showing a heat insulation container;

FIG. 3 is a diagram showing an example of a drive circuit having a heat-sensitive switch in the first embodiment;

FIG. 4A is an internal perspective sectional view showing a thermal fuse in the ON condition;

FIG. 4B is an internal perspective sectional view showing the thermal fuse in the OFF condition;

FIG. 5A is an internal perspective sectional view showing a magnetic material switching device in the ON condition;

FIG. 5B is an internal perspective sectional view showing the magnetic material switching device in the OFF condition;

FIG. 6 is a diagram showing another example of a drive circuit having the heat-sensitive switch in the first embodiment;

FIG. 7 is a view schematically showing a modification of the fuel cell system of the first embodiment;

FIG. 8 is a diagram showing a wire connection condition of the heat-sensitive switch in FIG. 7;

FIG. 9 is a diagram showing an example of a drive circuit having a heat-sensitive switch in a second embodiment;

FIG. 10 is a diagram showing another example of the drive circuit having the heat-sensitive switch in the second embodiment;

FIG. 11 is a diagram showing a drive circuit having a heat-sensitive switch in a third embodiment;

FIG. 12 is a view schematically showing a fuel cell system according to a fourth embodiment;

FIG. 13 is a diagram showing an example of a drive circuit in the fourth embodiment; and

FIG. 14 is a diagram showing another example of a drive circuit having a heat-sensitive switch in the fourth embodiment.

### DETAILED DESCRIPTION OF THE INVENTION

In the following, a variety of the manners for embodying the present invention will be described with reference to the accompanying drawings.

### First Embodiment

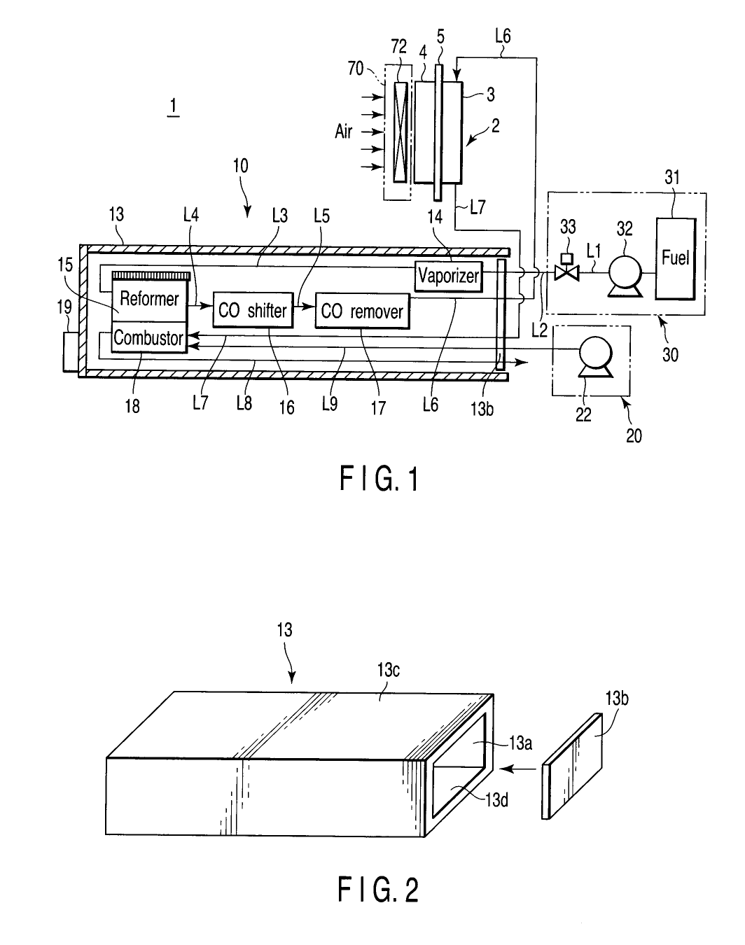

The fuel cell system according to the first embodiment of the present invention will be described by referring to FIGS. 1 to 6.

As shown in FIG. 1, a fuel cell system 1 is provided with a fuel cell unit 2, and a fuel reforming apparatus 10. The fuel cell unit 2 has a power generation stack prepared by laminating a fuel electrode (anode electrode) 3, an electrolyte membrane 5, and an oxidant electrode (cathode electrode) 4. The fuel cell unit 2 may have either of a single or plural power generation stacks, but usually the fuel cell unit 2 has a plurality of power generation stacks. Furthermore, the fuel cell unit 2 is provided with a blower fan 72 for delivering an oxidant (air) to the cathode electrode 4.

The fuel reforming apparatus 10 functions to produce a hydrogen-containing gas serving as a reformed gas from a liquid fuel and to supply the reformed gas to the fuel cell unit 2. The fuel reforming apparatus 10 is provided with a reformer 15 reforming the liquid fuel to produce the hydrogen-containing gas, and a combustor 18 for burning hydrogen gas with the oxidant to use the resulting combustion heat for heating the reformer 15. The fuel reforming apparatus 10 is usually provided further with a vaporizer 14 for vaporizing the liquid fuel before it is delivered to the reformer 15. Further, the fuel removing apparatus 10 may be provided also with a CO shifter 16 for shifting carbon monoxide (CO) contained in the hydrogen-containing gas obtained from the reformer 15 to carbon dioxide (CO₂), and a CO remover 17 for removing CO contained in the gas from the CO shifter 16.

Since the reforming reaction in the reformer 15 is conducted in a high temperature region of from 300° C. to 700° C., the major part of the fuel cell reforming apparatus 10, i.e., the vaporizer 14, the reformer 15, the CO shifter 16, the CO remover 17, and the combustor 18 are contained in a heat insulation container 13. Outside the heat insulation container 13, there are provided a fuel supply section 30 for supplying a liquid fuel to the reformer 15, and an oxidant supply section 20 for supplying an oxidant to the combustor 18. The oxidant supply section 20 has an air pump 22 functioning as a second electrical driving section.

The heat insulation container 13 is a vacuum heat insulation container having a hermetically-sealed double-walled structure, in which a vacuum space exists between an outer wall 13c and an inner wall 13d of the double-walled structure. A wall surface surrounding the vacuum space is covered with a metallic film such as an Ag film having a low emissivity or a metallic foil such as a copper foil and an aluminum foil having a low emissivity.

As shown in FIG. 2, the heat insulation container 13 is composed of, for example, a thin rectangular box in which an end surface (the surface having the minimum area) of the box in a direction perpendicular to the longitudinal side thereof is opened (an opening 13a). A heat insulation cover 13b is detachably attached to the heat insulation container 13 so as to close the opening 13a. The heat insulation cover 13b may be made from a heat insulating material such as mineral wools, ceramic fibers, calcium silicate, rigid foamed urethane, tiles, composite heat insulating materials, and communicated cell-structured materials. Examples of the composite heat insulating materials include a laminate sheet prepared by laminating Al layers onto both the surfaces of a ceramic fiber layer or a calcium silicate layer. Examples of the communicated cell-structured material include a ceramics powder sintered body which is reinforced with an inorganic fiber and has communicated cells (unclosed cells) each having 0.1 μm or less diameter such as “Microtherm” (trade name; manufactured by Nippon Microtherm Co., Ltd.). Among others, particularly, the communicated cell-structured material exhibits sufficient heat resistance even at a high temperature of 150° C. Although in the present embodiment, the heat insulation container 13 has a flat rectangular parallelepiped shape, cubic, cylindrical, or elliptic cylindrical shapes may also be applied.

The vaporizer 14 is connected to the fuel supply section 30 through a line L2, while the vaporizer 14 is connected to the reformer 15 through a line L3. In FIG. 1, although the vaporizer 14 is shown at a position distant from the combustor 18 for the purpose of convenience, it is actually arranged such that the vaporizer 14 is disposed in close vicinity to the combustor 18, and thermal energy of the combustion in the combustor 18 is transmitted to the vaporizer 14 through a heat transfer plate (e.g. copper plate) (not shown), whereby the fuel flowing through the inside of the vaporizer 14 is heated and vaporized. Inside the vaporizer 14, a serpentine-shaped or parallel-shaped channel flow path is provided. When a liquid fuel is supplied to the vaporizer 14 through the line L2, the liquid fuel is heated by the combustor 18 to be vaporized while flowing through the inner flow path of the vaporizer 14.

The reformer 15 reforms the liquid fuel which has been vaporized by the vaporizer 14 and introduced into the reformer 15 through the line L3 to produce a hydrogen-containing gas (reformed gas). Inside the reformer 15, a serpentine-shaped or parallel-shaped channel flow path is formed as in the case of the vaporizer 14, and the flow path is adapted such that the vaporized fuel is circulated therethrough. An inner wall of the flow path is made from an anodized porous body, and the porous body is impregnated with a reforming catalyst. The reforming catalyst promotes the reforming reaction from the vaporized fuel to the reformed gas.

The reformer 15 is in contact with the combustor 18 such that the combustion heat from the combustor 18 is transmitted efficiently to the reformer 15. For the sake of transmitting efficiently the combustion heat generated inside the combustor 18 to the inside of the reformer 15, it is desired that at least a part of a reaction vessel constituting the reformer 15 is formed from a material having a high thermal conductivity. Examples of the material for the reaction vessel include aluminum, copper, aluminum alloys, and copper alloys. Stainless steel having excellent corrosion resistance may be used, although the stainless steel has a lower coefficient of the thermal conductivity than that of aluminum, copper and the like.

The reaction vessel of the reformer 15 may be formed in accordance with a general-purpose machining method or molding method. Examples of the general-purpose machining method include electric-discharge machining, milling machining and the like. On the other hand, examples of the general-purpose molding method include forge processing, cast processing and the like. Moreover, a machining method may be applied in combination with a molding method, for example, such that a reaction vessel with which no inlet piping and outlet piping are provided is molded by means of cast processing, and thereafter, throughholes are bored by means of a machining method such as drill processing, and then, a channel material is welded to the thus processed reaction vessel.

As a reforming catalyst used in the reformer 15, Cu/ZnO/γ-alumina, or Pd/ZnO, platinum-alumina-based catalysts (Pt/Al₂O₃) or the like may be used in the case where methanol is used as the fuel. Such reforming catalysts promote the reaction of the following formula (1), i.e., steam reforming reaction in which methanol is reformed into hydrogen and carbon dioxide.

CH₃OH+H₂O→3H₂+CO₂ (1)

In the case where the fuel contains dimethylether, a mixture of Pd/ZnO and γ-alumina, or platinum-alumina-based catalysts (Pt/Al₂O₃) and the like may be used. Such reforming catalysts promote the reaction expressed by the following formula (2), i.e., the steam reforming reaction of dimethylether.

CH₃OCH₃+3H₂O→6H₂+2CO₂ (2)

In the platinum-alumina-based catalysts, it is preferred that a Pt-supporting amount is from 0.25% by mass or more to 1.0% by mass or less. When the inner wall of a flow path is impregnated with a reforming catalyst supporting a noble metal, durability of the reformer 15 is improved. A temperature range within which a reforming catalyst functions efficiently extends from 200 to 400° C. It is preferred to control the temperature of the reformer 15 such that a temperature of the surface of the reforming catalyst is within a range of 200 to 400° C.

A reformed gas contains carbon dioxide and carbon monoxide as the by-products other than hydrogen. Carbon monoxide (CO) deteriorates the anode catalyst of the fuel electrode 3, resulting in a cause for decreasing power generation performance of the fuel cell unit 2. Accordingly, it is preferred to intend that the reformed gas is delivered from the reformer 15 to the CO shifter 16 through the line L4, carbon monoxide is shift-reacted into carbon dioxide and hydrogen to decrease the CO concentration, and further to increase an amount of the hydrogen production.

The basic structure of the CO shifter 16 is the same as that of the reformer 15. Inside the CO shifter 16, a serpentine-flow or co-flow path is provided as in the case of the reformer 15. A porous inner wall of the flow path is impregnated with a shift reaction catalyst. The shift reaction catalyst is prepared by supporting a noble metal such as Pt, Pd, and Ru on a heat-resistant carrier. Such a shift reaction catalyst accelerates a shift reaction in accordance with the reaction of the following formula (3) in which carbon monoxide is further shifted to carbon dioxide to increase an amount of hydrogen production.

CO+H₂O→H₂+CO₂ (3)

An alumina carrier stabilized with Ce, Re or the like may be used for a shift reaction catalyst. Furthermore, well-known Cu/ZnO-based catalysts may be used as a shift reaction catalyst other than that described above. However, in the case where durability of the CO shifter 16 is intended to improve, it is preferred to use a catalyst supported with a noble metal including Pt. A temperature range within which a CO shift reaction catalyst functions efficiently extends from 200 to 300° C. In this respect, it is preferred to control a temperature of the CO shifter 16 by the use of the combustor 18 such that the temperature on the surface of the CO shift reaction catalyst is within a range of 200 to 300° C.

The reformed gas which is subjected to a shift reaction in the CO shifter 16 still contains around 1% to 2% of carbon monoxide. Carbon monoxide deteriorates the anode catalyst of a fuel cell as mentioned above, resulting in a cause for decreasing power generation performance. For this reason, it is preferred that the reformed gas is delivered from the CO shifter 16 to the CO remover 17 through a line L5, and carbon monoxide is further removed from the reformed gas.

The basic structure of the CO remover 17 is the same as that of the reformer 15. Namely, a serpentine-flow or co-flow path is provided inside the CO remover 17 as in the case of the reformer 15 and the CO shifter 16. An inner wall of the flow path is made from an anodized porous body which is impregnated with a methanation reaction catalyst including Ru. Such methanation reaction catalyst promotes the methanation reaction of carbon monoxide contained in the reformed gas.

The CO remover 17 methanates carbon monoxide in the reformed gas in accordance with the reaction of the following formula (4) to remove the carbon monoxide from the reformed gas until the CO concentration reaches 100 ppm or less.

CO+3H₂→CH₄+H₂O (4)

Examples of such methanation reaction catalysts include the one containing Ru/Al₂O₃, Ru/zeolite, Ru/Al₂O₃, or Ru/zeolite as a major component and supported with at least one element selected from Mg, Ca, K, La, Ce, and Re.

An outlet of the CO remover 17 is connected to the anode electrode 3 of the fuel cell unit 2 through a line L6. The line L6 penetrates the heat insulation cover 13b to be drawn out of the heat insulation container 13, and it is connected to the anode electrode 3 of the fuel cell unit 2. The reformed gas from which carbon monoxide has been removed is supplied from the CO remover 17 to the anode electrode 3 through the line L6, and it reacts with oxygen in the air to generate power.

To the combustor 18, two supply lines L7 and L9 as well as one exhaust line L8 are connected. The supply line L7 is provided between the anode electrode 3 of the fuel cell unit 2 and the combustor 18. The supply line L9 is provided between the air pump 22 and the combustor 18. Through the line L7, unreacted hydrogen-containing gas (the reformed gas after power generation reaction) is supplied to the combustor 18 from the anode electrode 3, and further, when the air discharged from the air pump 22 is supplied through the line L9, combustion heat is produced by oxidative combustion reaction. The resulting combustion heat is used for heating the vaporizer 14, the reformer 15, the CO shifter 16, and the CO remover 17. To the combustor 18, the line L8 is connected for discharging the combustion gas to outside of the heat insulation container 13. The discharging line L8 penetrates the heat insulation cover 13b to be drawn out of the heat insulation container 13, and it is communicated with outside of the fuel cell system.

The basic structure of the combustor 18 is the same as that of the reformer 15. Namely, a serpentine-shaped or parallel-shaped channel flow path is provided inside the combustor 18. An inner wall of the flow path is made from an anodized porous body which is impregnated with a combustion catalyst such as alumina obtained from the porous body supported by a noble metal such as Pt, Pd, or the mixtures thereof. The reason why such a noble metal is used for the combustion catalyst is that these noble metals are hardly oxidized and deteriorated by the air which will invade into the system, when the fuel cell system is stopped. When the catalysts supported by the metals other than noble metals are used in the combustor 18, it is required to provide a supplementary facility for preventing oxidation of the catalysts. A heater (not shown) may be attached to the combustor 18, whereby the combustion heat may be used together with the heat produced by the heater. As the heater, for example, the one prepared by applying a ceramics heater onto an aluminum plate, the one prepared by embedding a rod heater in an aluminum plate or the like may be used.

The fuel supply section 30 is provided with a fuel container 31, a fuel pump 31 serving as an electrical driving section, and a fuel stop valve 33. In the fuel container 31, a liquid fuel including organic compounds containing carbon and hydrogen such as methanol, a mixture of methanol and water, a mixture of dimethylether and water, or a mixture of dimethylether, water and alcohol is stored. As the alcohols, methanol, ethanol and the like are preferred. Among them, methanol is particularly preferable, because the mutual solubility of dimethylether and water is improved thereby. The fuel container 31, the fuel pump 32, and the fuel stop valve 33 are serially connected by means of the fuel supply line L1 in this order. When the pump 32 is driven, a fuel in the fuel container 30 is discharged from the pump 32, and it is supplied to the reformer 15 through the fuel supply line L1.

Next, details of the fuel cell unit 2 will be described. The anode electrode 3 and the cathode electrode 4 are made from a porous sheet prepared by holding a carbon black powder supported by, for example, Pt with a water-repellant resin binding material such as polytetrafluoroethylene (PTFE), respectively. The electrolyte membrane 5 is, for example, a fluorocarbon polymer having a cation-exchange group such as a sulfonic acid group, or a carboxylic acid group; a basic high-molecular compound such as polybenzimidazole (PBI) doped with phosphoric acid, for example, “Nafion” (trade name of Du Pont Company); and the like. The anode electrode 3 and the cathode electrode 4 may contain a sulfonic acid type perfluorocarbon polymer, or fine particles covered with the perfluorocarbon polymer.

Hydrogen in the reformed gas supplied to the anode electrode 3 reacts in the anode electrode 3 as expressed in the following formula (5).

H₂→2H⁺+2e⁻ (5)

On the other hand, the oxygen supplied to the cathode electrode 4 reacts in the cathode electrode 4 as expressed in the following formula (6).

1/2O₂+2H⁺+2e⁻→H₂O (6)

A heat-sensitive switch 19 is attached to the outer wall 13c of the heat insulation container 13, preferably it is attached so as to be in contact with the outer wall 13c in the vicinity of the reformer 15. The heat-sensitive switch 19 maintains the ON condition as long as the temperature of the outer wall 13c is within the set value, while when, for example, the heat insulation container 13 is damaged, the temperature of the outer wall 13c rises, and the temperature thereof is over the set value, the heat-sensitive switch 19 becomes the OFF condition.

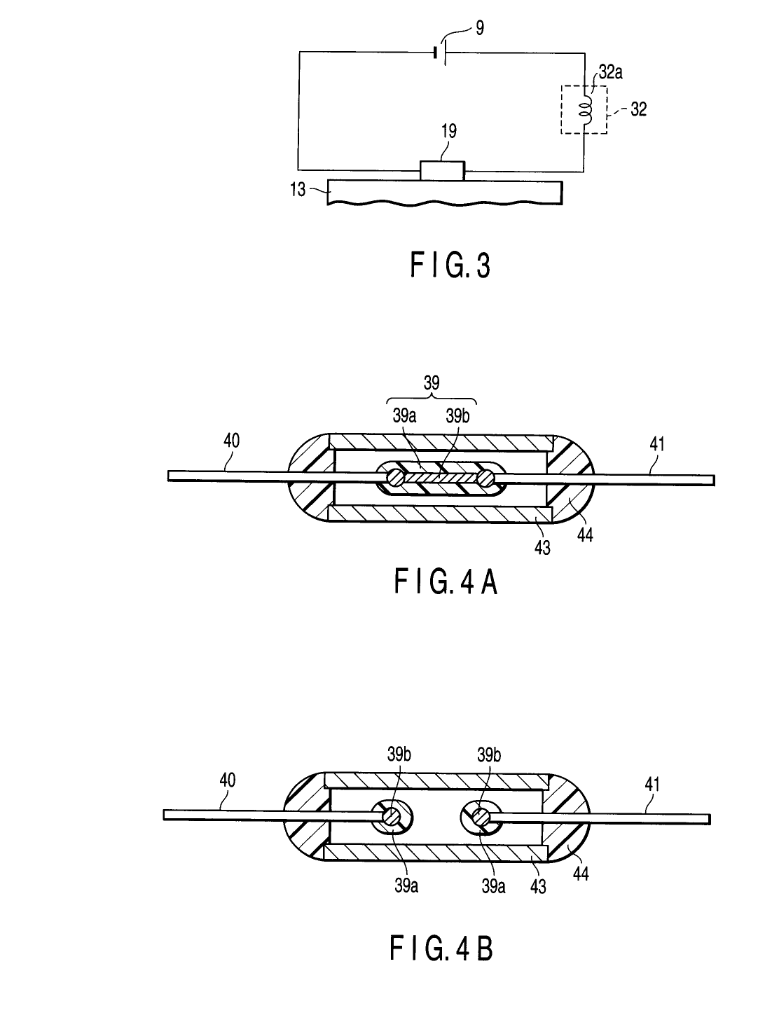

As shown in FIG. 3, an armature coil 32a of the fuel pump 32 is connected to a power source 9 through the heat-sensitive switch 19. In other words, the heat-sensitive switch 19 is serially connected to the armature coil 32a with respect to the power source 9. The fuel pump 32 is composed of a DC motor including the armature coil 32a, and a vane wheel driven by the DC motor.

When a temperature of the outer wall of the heat insulation container 13 is over the set value so that the heat-sensitive switch 19 becomes the OFF condition, the power feeding from the power source 9 to the armature coil 32a of the fuel pump 32 is stopped. As a result, the fuel pump 32 is stopped, and a fuel comes to be not supplied from the fuel supply section 30 to the reformer 15. According to such arrangement as described above, an abnormal temperature rise in the fuel reforming apparatus 10 is prevented from occurring, whereby the safety of the fuel cell system 1 is improved.

Although the fuel cell unit 2 in the present system may be used for the power source 9, an external power supply such as a secondary battery, or the other fuel cell unit may be used. When such an external power supply is used, the fuel pump 32 can start rapidly. Furthermore, an arrangement may be such that an external power supply is used as a starter power source, and the fuel cell unit 2 is used as the power source 9 after starting the fuel cell system 1.

The fuel stop valve 33 is an electromagnetic valve connected to the inlet of the vaporizer 14 through the line L2. The stop valve 33 may be arranged such that it is manually closed, or it is automatically closed by means of the heat-sensitive switch 19 (e.g., a bimetal switching device) as mentioned later. When the stop valve 33 is closed, supply of the fuel from the fuel supply section 30 to the vaporizer 14 is stopped, and then, the reforming reactions (the above-mentioned reactions (1) and (2)) in the reformer 15 are stopped.

The heat-sensitive switch 19 is a switch having a temperature detecting function. When the temperature detected exceeds the set value (operation temperature) as described above, it conducts switching operations (ON/OFF operations). For the heat-sensitive switch 19, either of a non-return type and a return type switches may be used. The “non-return type heat-sensitive switch” means a switch which cannot return to the original ON condition once it becomes the OFF condition; and an example thereof includes a thermal fuse, and a magnetic material switching device. Accordingly, such non-return type heat-sensitive switch must be replaced inevitably by a spare switch before the following use after the heat-sensitive switch becomes the OFF condition. The “return type heat-sensitive switch” means a switch which can return to the original ON condition after it becomes the OFF condition. Accordingly, such switch is not required to be replaced by a spare switch even after the switch was once in the OFF condition. An example of the return type heat-sensitive switches includes a positive temperature coefficient (PTC) thermistor, a negative temperature coefficient (NTC) thermistor, and bimetal switches. When it is considered that the safety in a fuel cell is important, it is preferred to use a non-return type thermal fuse or a magnetic material switch. The “bimetal switch” means a switch which effects ON/OFF operations by utilizing thermal displacement of the bimetal. The “magnetic material switch” means a switch which effects ON/OFF operations by utilizing such characteristics of the magnetic material that ferromagnetism disappears in the temperature range over Curie point (Curie temperature).

FIGS. 4A and 4B show a well-known thermal fuse which is applicable for the heat-sensitive switch 19. The thermal fuse is, for example, a soluble alloy type thermal fuse. In this type of a thermal fuse, a pair of lead wires 40 and 41 is electrically connected with each other by disposing a soluble material 39 therebetween as shown in FIG. 4A. The soluble material 39 is prepared by covering a low-melting point alloy (soluble alloy) 39b with a resin 39a containing principally rosin (pine tar). The resin 39a exhibits such a behavior that it fluidizes in a temperature range over the melting point of the alloy 39b, while it solidifies rapidly in a temperature range under the melting point of the alloy 39b.

The soluble material 39 is contained in an insulating case 43, and the lead wires 40 and 41 are drawn out respectively from the case 43 under such condition that the both ends of the case 43 are sealed by an epoxy resin 44 for assuring the airtightness. Due to the temperature rise of the outer wall of the heat insulation container, when the temperature exceeds the melting point of the alloy 39b, the alloy 39b melts to break so that each end of the lead wires 40 and 41 separated are covered with the resin 39a as shown in FIG. 4B, and thus, the circuit is shut off. It is to be noted that although an example of the soluble alloy type thermal fuse is described as the heat-sensitive switch herein, a temperature-sensitive pellet type thermal fuse may also be applied.

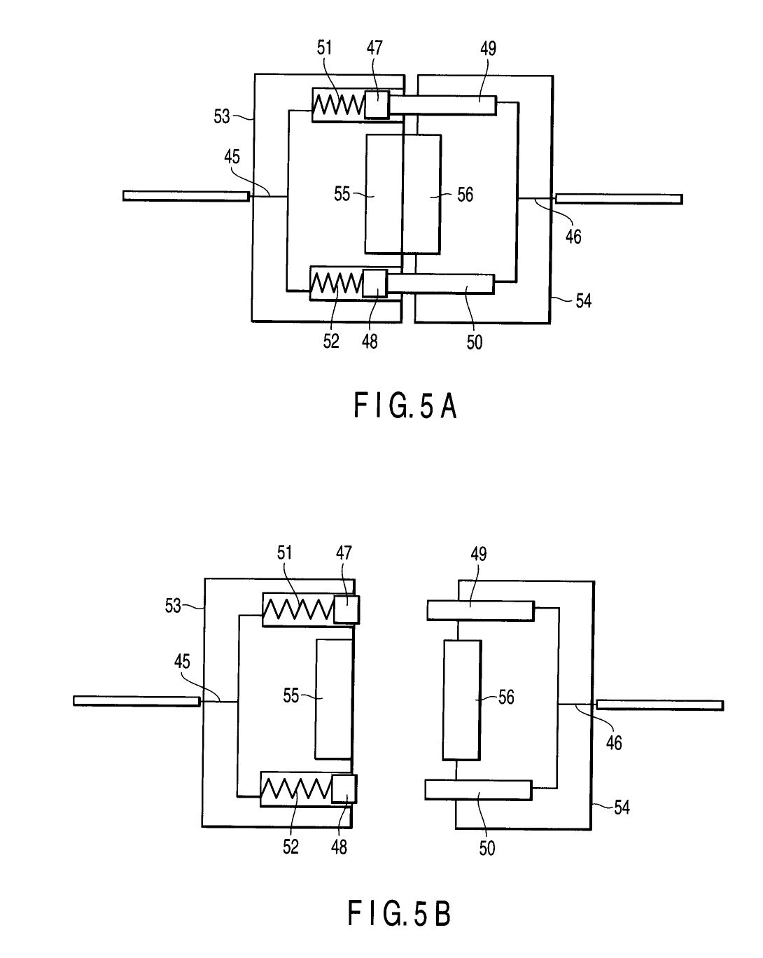

Next, an example in which a magnetic material switching device is used for the heat-sensitive switch 19 will be described by referring to FIGS. 5A and 5B. In the magnetic material switching device, when a temperature-sensitive magnetic material 55 is in contact with a permanent magnet 56, the magnetic material switching device is in the ON condition as shown in FIG. 5A. On the other hand, when the temperature-sensitive magnetic material 55 is separated from the permanent magnet 56, the magnetic material switching device is in the OFF condition as shown in FIG. 5B.

A pair of lead wires 45 and 46 in the magnetic material switching device is connected to the ground side of a drive circuit (not shown). The lead wires 45 and 46 are electrically connected to each other through movable terminals 47 and 48 as well as fixed terminals 49 and 50, respectively. The movable terminals 47 and 48 are energized by springs 51 and 52, respectively, and these movable terminals are conductive in a contact state with respect to the fixed terminals 49 and 50, respectively, as shown in FIG. 5A. The lead wire 45, the movable terminals 47 and 48, and the springs 51 and 52 are attached to one insulating case 53. The lead wire 46, and the fixed terminals 49 and 50 are attached to the other insulating case 54.

The temperature-sensitive magnetic material 55 is attached to the former insulating case 53, while the permanent magnet 56 is attached to the other insulating case 54. The temperature-sensitive magnetic material 55 is disposed so as to oppose to the permanent magnet 56.

The temperature-sensitive magnetic material 55 has a predetermined Curie point. The temperature-sensitive magnetic material 55 exhibits ferromagnetism at a lower temperature than the Curie point. As a result, a remarkable attraction force appears between the temperature-sensitive magnetic material 55 and the permanent magnet 56. Since the attraction force thus appeared exceeds the energization force of the springs 51 and 52, the condition of switch ON is maintained as shown in FIG. 5A. However, when the temperature of the outer wall 13c of the heat insulation container 13 rises and the temperature of the temperature-sensitive magnetic material 55 exceeds the Curie point, the temperature-sensitive magnetic material 55 loses the ferromagnetism, so that the attraction force existing between the temperature-sensitive magnetic material 55 and the permanent magnet 56 disappears. As a result, repulsive force appears between the insulating case 53 and the insulating case 54 due to the energization force of the springs 51 and 52, whereby the movable terminals 47 and 48 are detached from the fixed terminals 49 and 50, respectively, resulting in the switch OFF condition.

A well-known PTC thermistor may be used for the heat-sensitive switch 19. For the PTC thermistor, for example, a polymer PTC prepared by adding a conductive carbon filler to a polymer being an insulating material, a ceramics PTC containing barium titanate (BaTiO₃) as a major component and the like may be used. Moreover, a well-known NTC thermistor may be used for the heat-sensitive switch 19. For the NTC thermistor, for example, oxide sintered bodies of Mn, Co, Ni, Fe and the like may be used.

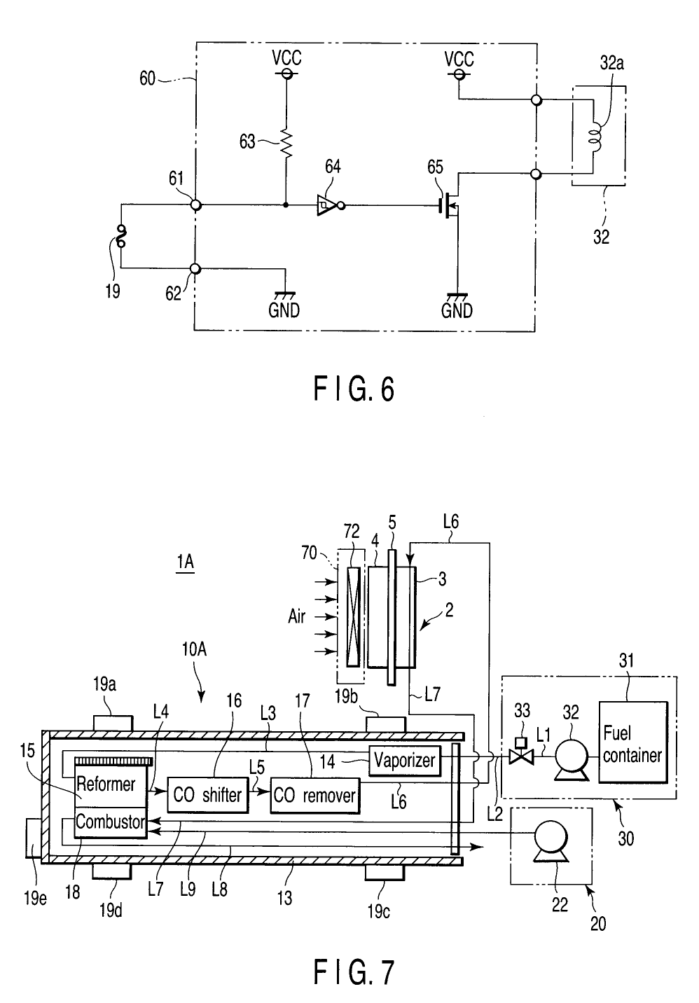

Next, a modification of the first embodiment will be described by referring to FIG. 6. According to FIG. 6, both ends of the heat-sensitive switch 19 are connected to a control terminal 61 and a ground terminal 62 of a drive circuit (electric current producing section) 60, respectively. The ground terminal 62 is connected to the ground GND. The drive circuit 60 functioning as the electric current producing section involves a pull-up resistor 63, an inverter 64, and a transistor 65, e.g., an N-channel type MOS field effect transistor (MOSFET). The control terminal 61 is connected to a power source VCC through the resistor 63, and at the same time, to the gate terminal of the transistor 65 through the inverter 64. The drain terminal of the transistor 65 is connected to an end of the armature coil 32a of the fuel pump 32. The source terminal of the transistor 65 is connected to the ground GND. The other end of the armature coil 32a is connected to the power source VCC. For the power source VCC, the fuel cell unit 2 may be used, or an external power supply, e.g., a secondary battery or the other fuel cell unit may be used as in the case of the power source 9 shown in FIG. 3.

For the heat-sensitive switch 19, for example, a thermal fuse is used. When the heat-sensitive switch 19 is in the ON condition, the electric potential of the control terminal 61 is in ground electric potential, i.e., in a low level (Low). Accordingly, the output of the inverter 64, i.e., the electric potential at the gate terminal of the transistor 65 is in a high level (High), so that the transistor 65 becomes the ON condition. Thus, an electric current flows through the armature coil 32a via the transistor 65, whereby the fuel pump 32 discharges a fuel so that the fuel is supplied from the fuel supply section 30 to the reformer 18.

On the other hand, when the temperature of the outer wall 13c exceeds a set value due to, for example, a damage of the heat insulation container 13, and the heat-sensitive switch 19 becomes the OFF condition, the control terminal 61 becomes a H-level (high level), while the output of the inverter 64 becomes a L-level (low level). As a result, the transistor 65 becomes the OFF condition, whereby the feed of electric current to the armature coil 32a is shut off so that the fuel pump 32 stops, resulting in stoppage of supply of the fuel from the fuel supply section 30 to the reformer 15.

According to the present embodiment, even if the heat insulation container 13 is damaged, the heat-sensitive switch 19 becomes the OFF condition due to the abnormal temperature rise of the outer wall 13c. Thus, the fuel pump 32 stops, and supply of the fuel to the reformer 15 is stopped. As a result, the reforming reaction in the reformer 15 is stopped, whereby overheating of the outer wall 13c of the heat insulation container 13 or the peripheral part thereof is prevented. Hence, particularly the safety of an apparatus with respect to an external impact in case of dropping the apparatus is improved. Therefore, the fuel cell system according to the present embodiment may be used with a safe conscience for the power source to be used in handheld or compact electronic devices such as a notebook-size personal computer in addition to portable power sources; and thus, the fuel cell system of the present embodiment exhibits high reliability.

As shown in FIG. 7, a plurality of heat-sensitive switches 19a to 19e may be disposed at a plurality of places on the outer wall 13c of the heat insulation container 13. Among the heat-sensitive switches 19a to 19e, for example, the heat-sensitive switches 19a and 19c are disposed on the principal surfaces of the heat insulation container 13 so as to oppose to each other, respectively; the heat-sensitive switches 19b and 19d are disposed on the side surfaces of the heat insulation container 13 so as to oppose to each other, respectively; and the heat-sensitive switch 19e is disposed on an end surface of the heat insulation container 13. No heat-sensitive switch is attached to the heat insulation cover 13b for closing the opening 13d. This is because there is no space for attaching such heat-sensitive switch, since the lines L2, L6, L7, L8, and L9 pass through the heat insulation cover 13b.

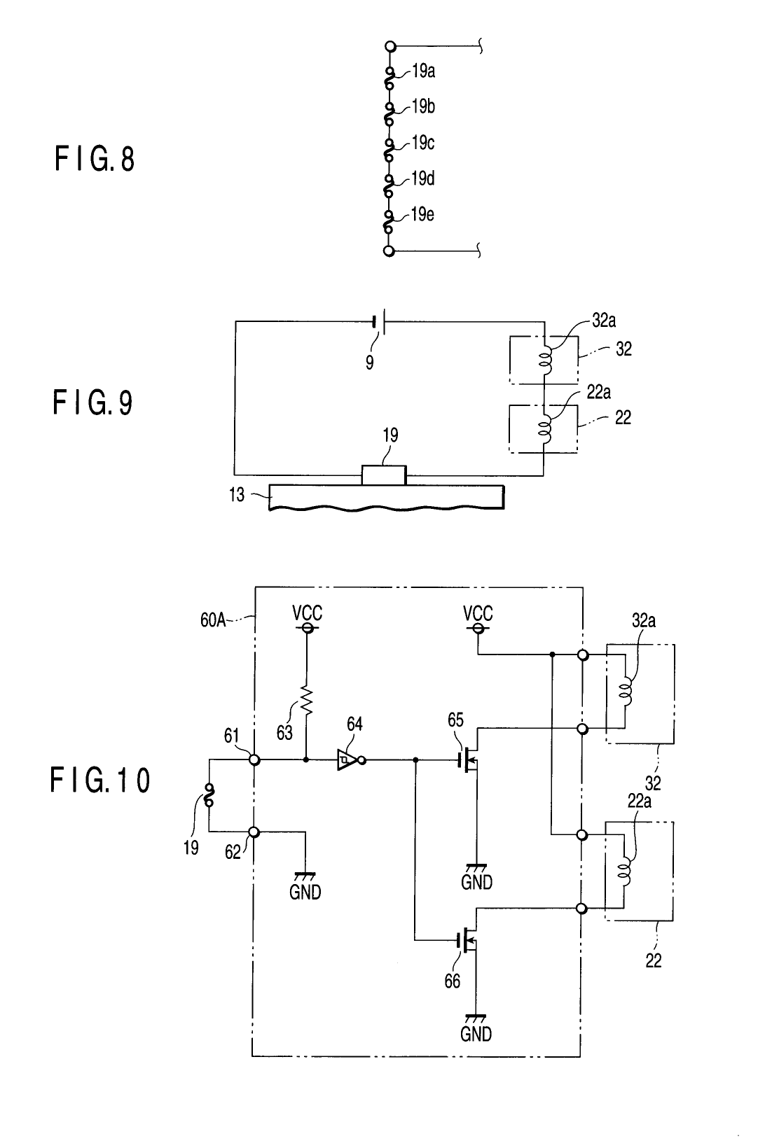

The heat-sensitive switches 19a to 19e are connected serially to each other as shown in FIG. 8. Namely, the heat-sensitive switch 19 shown in FIG. 3 or 6 is replaced by the plurality of heat-sensitive switches 19a to 19e connected serially to each other. In this case, when at least one of the heat-sensitive switches 19a to 19e becomes the OFF condition, the fuel pump 32 is stopped to cease supply of the fuel to the reformer 15.

Heat-sensitive switches each having a different set value (operating temperature) from one another may be combined for the heat-sensitive switches 19a, 19b, 19c, 19d, and 19e. Furthermore, a return type heat-sensitive switch may be combined with a non-return type heat-sensitive switch. For instance, a return type heat-sensitive switch having an operating temperature of 70° C. (e.g., a PTC thermistor) may be combined with a non-return type heat-sensitive switch having an operating temperature of 130° C. (e.g., a thermal fuse). According to such arrangement as described above, when the return-type heat-sensitive switch is returned in case of a light-grade damage of the heat insulation container 13, operation of the fuel reforming apparatus 10 can be started again. In case of a severe damage of the heat insulation container 13, the whole of the damaged heat insulation container 13 involving the heat-sensitive switches may be exchanged by a brand-new.

### Second Embodiment

Next, a fuel cell system according to a second embodiment will be described by referring to FIGS. 9 and 10. The part of description in the present embodiment overlapping that of the first embodiment will be omitted.

In the fuel cell system of the present embodiment, for example, an armature coil 32a of a fuel pump 32 and an armature coil 22a of an air pump 22 are connected to a power source 9 through a heat-sensitive switch 19 as shown in FIG. 9. In other words, the heat-sensitive switch 19 is connected serially to the armature coils 32a and 22a with respect to the power source 9.

When the temperature of an outer wall 13c of a heat insulation container 13 exceeds a set value so that the heat-sensitive switch 19 becomes the OFF condition, power feeding from the power source 9 to the armature coil 32a of the fuel pump 32 and the armature coil 22a of the air pump 22 is stopped. As a result, the fuel pump 32 is stopped and thus supply of a fuel from a fuel supply section 30 to a reformer 15 is stopped as in the case of the first embodiment. In addition, the air pump 22 is stopped, and supply of an oxidant from an oxidant supply section 20 to a combustor 18 is also stopped.

Next, a modification of the second embodiment will be described by referring to FIG. 10. A drive circuit 60A shown in FIG. 10 is the one to which one more transistor 66, e.g., an N-channel type MOSFET is added to the drive circuit 60 shown in FIG. 6. The gate terminal of the transistor 66 is connected to a control terminal 61 through an inverter 64 as in the case of a transistor 65. The drain terminal of the transistor 66 is connected to an end of the armature coil 22a of the air pump 22. The source terminal of the transistor 66 is connected to the ground GND. The other end of the armature coil 22a is connected to a power supply VCC.

In the case where the temperature of the outer wall 13c of the heat insulation container 13 is equal to or less than a set value and the heat-sensitive switch 19 (for example, a thermal fuse is used) is in the ON condition, an electric potential of the control terminal 61 is in a L-level as mentioned before. Accordingly, an output of the inverter 64, i.e., the gate terminals of the transistors 65 and 66 become a H-level, so that the transistor 66 becomes the ON condition together with the transistor 65. In this case, since electric current flows through the armature coil 22a via the transistor 66, the air pump 22 discharges air, and the air, i.e., an oxidant is supplied from the oxidant supply section 20 to the combustor 18.

On the other hand, when a temperature of the outer wall 13c exceeds the set value due to, for example, a damage of the heat insulation container 13 so that the heat-sensitive switch 19 becomes the OFF condition, the electric potential of the control terminal 61 becomes a H-level, while the output of the inverter 64 comes to be a L-level. Thus, the transistor 66 becomes the OFF condition together with the transistor 65, whereby power feeding to the armature coil 22a is shut off, so that the air pump 22 is stopped, resulting in stoppage of the supply of the oxidant to the combustor 18.

According to the second embodiment, when the temperature of the outer wall 13c of the heat insulation container 13 exceeds the set value, the air pump 22 is stopped further in addition to the stoppage of the fuel pump 32 as mentioned above, whereby an abnormal temperature rise of the fuel reforming apparatus 10 is more positively prevented, so that safety of the fuel cell system 1 is more improved. Namely, continuation of the temperature rise of the outer wall 13c of the heat insulation container 13 which might continue even after supply of the liquid fuel is stopped can be prevented. Such continuation of the temperature rise is due to the fact that a combustible gas remaining in lines L2 to L7, a flow path of the reformer 15, or the fuel cell unit 2 continues to burn in the combustor 18. As mentioned above, when the temperature of the outer wall 13c of the heat insulation container 13 exceeds the set value, both the reforming reaction in the reformer 15 and the combustion reaction in the combustor 18 stop, whereby the overheating of the outer wall 13c of the heat insulation container 13 and the peripheral part thereof is more positively prevented. Therefore, safety of the apparatus with respect to an external impact in case of particularly dropping the apparatus is more improved.

In the case when the air pump 22 is stopped, in order to further prevent the unreacted combustible gas flowed into the combustor 18 from leaking to the outside as it is without any combustion, a catalytic combustor may be provided outside the heat insulation container 13 in the downstream of a discharge line L8.

### Third Embodiment

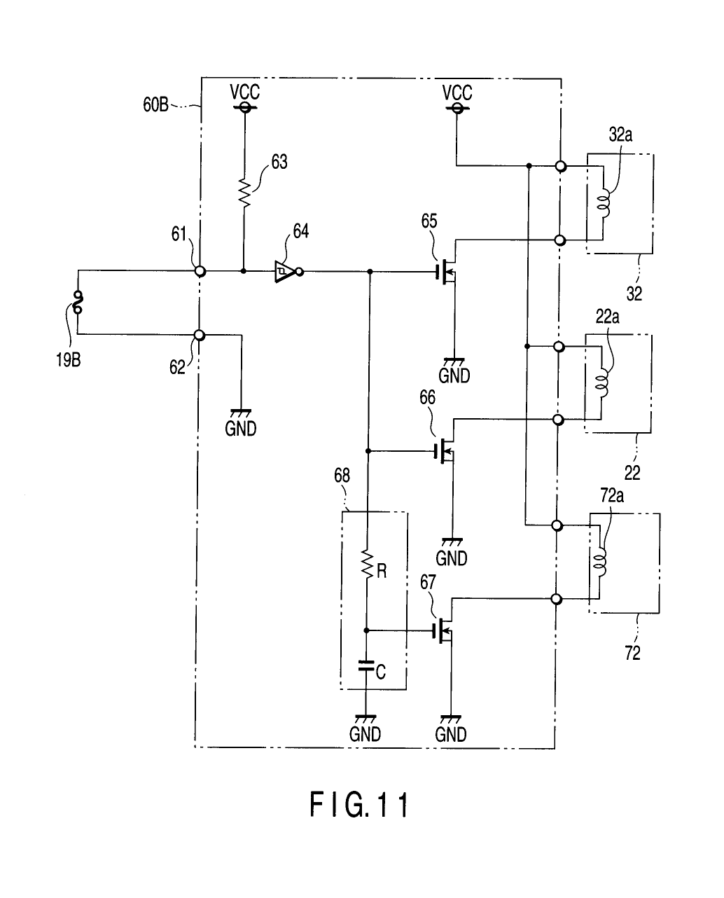

Next, a fuel cell system according to a third embodiment will be described by referring to FIG. 11. The part of description in the present embodiment overlapping that of the second embodiment will be omitted.

According to the fuel cell system of the present embodiment, a drive circuit 60B shown in FIG. 11 is the one to which one more transistor 67, e.g., an N-channel type MOSFET and a timer circuit 68 are added to the drive circuit 60A shown in FIG. 10. The gate terminal of the transistor 67 is connected to a control terminal 61 through an inverter 64 as in the case of transistors 65 and 66. The drain terminal of the transistor 67 is connected to an end of the armature coil 72a of a motor of a blower fan 72. The source terminal of the transistor 67 is connected to the ground GND. The other end of the armature coil 72a is connected to a power supply VCC.

The timer circuit 68 is a time constant circuit containing a resistor R and a capacitor C connected serially to each other. An end of the resistor R is connected to the control terminal 61 through the inverter 64, and a contact point of the other end of the resistor R and an end of the capacitor C is connected to the gate terminal of the transistor 67. The other end of the capacitor C is connected to the ground GND.

According to the present embodiment, when a temperature of the heat insulation container 13 exceeds the set value as described in FIG. 10, a fuel pump 32 and an air pump 22 are stopped, and further the blower fan 72 is also stopped. In this case, when all of the fuel pump 32, the air pump 22, and the blower fan 72 are stopped at the same time, an exhaust gas containing a large amount of unreacted hydrogen flows into a combustor 18 from a fuel cell unit 2, so that it is not desirable. Accordingly, in the present embodiment, the blower fan 72 is stopped with a predetermined delay with respect to the stoppage of the fuel pump 32 and the air pump 22. In the following, specific operations are described.

In the steady state in which an outer wall temperature of the heat insulation container 13 is equal to or less than the set value, and a heat-sensitive switch 19 is in the ON condition, an electric potential at the control terminal 61 is in a L-level, while an electric potential at the gate terminals of the transistors 65 and 66 are in a H-level as mentioned above, so that both the transistors 65 and 66 become the ON conditions, respectively. In this case, since an electric current flows into armature coils 32a and 22a through the transistors 65 and 66, respectively, the fuel pump 32 discharges a liquid fuel, while the air pump 22 discharges air. Thus, the liquid fuel is supplied to a reformer 15 from a fuel supply section 30, while an oxidant is supplied to the combustor 18 from an oxidant supply section 20.

On the other hand, when the temperature of the outer wall 13c exceeds the set value so that the heat-sensitive switch 19 becomes the OFF condition due to, for example, a damage of the heat insulation container 13 or the like, the electric potential at the control terminal 61 becomes a H-level, while the electric potential at the gate terminals of the transistors 65 and 66 become a L-level, so that both the transistors 65 and 66 become the OFF conditions. As a result, the feeding of electric current to the armature coils 32a and 22a is shut off, whereby both the fuel pump 32 and the air pump 22 stop, so that supply of the liquid fuel to the reformer 15 and supply of the oxidant to the combustor 18 are stopped. In this case, even when the gate terminals of the transistors 65 and 66 become a L-level, a charging voltage of the capacitor C remains, so that the gate terminal of the transistor 67 is still in a H-level. Accordingly, even when the fuel pump 32 and the air pump 22 stop, the blower fan 72 continues to operate.

Then, when the temperature of the outer wall of the heat insulation container 13 exceeds the set value and a certain period of time is elapsed from the time when the heat-sensitive switch 19 becomes the OFF condition to the time determined by time constants of the CR, an output of the timer circuit 68, i.e., the gate terminal of the transistor 67 becomes low (L), whereby the transistor 67 becomes the OFF condition. Thus, the electric current feeding to the armature coil 72a is shut off, so that the blower fan 72 stops. As described above, the blower fan 72 is stopped at a timing which delays for a certain period of time from the stoppage of the fuel pump 32 and the air pump 22.

As described above, according to the present embodiment, since supply of air to a cathode electrode 4 of the fuel cell unit is stopped with a delay of a certain period of time after both supply of a fuel to the reformer 15 and supply of an oxidant to the combustor 18 are stopped, overheating of the combustor 18 can be prevented. This is because, when stoppage of the air supply to the cathode electrode 4 is made simultaneously with stoppage of the fuel supply and stoppage of the oxidant supply, an extra reformed gas (unreacted gas) remaining in flow paths L3 to L7 enters the combustor 18 and burns therein. Particularly, a vaporizer 14, the reformer 15, a CO shifter 16, and a CO remover 17 have long flow paths, respectively, in a fuel reforming apparatus 10, so that when a sufficient delay time is set by means of the timer circuit 68, a remaining amount of the reformed gas (unreacted combustible gas) in these flow paths decreases, whereby overheating of the combustor 18 is prevented.

### Fourth Embodiment

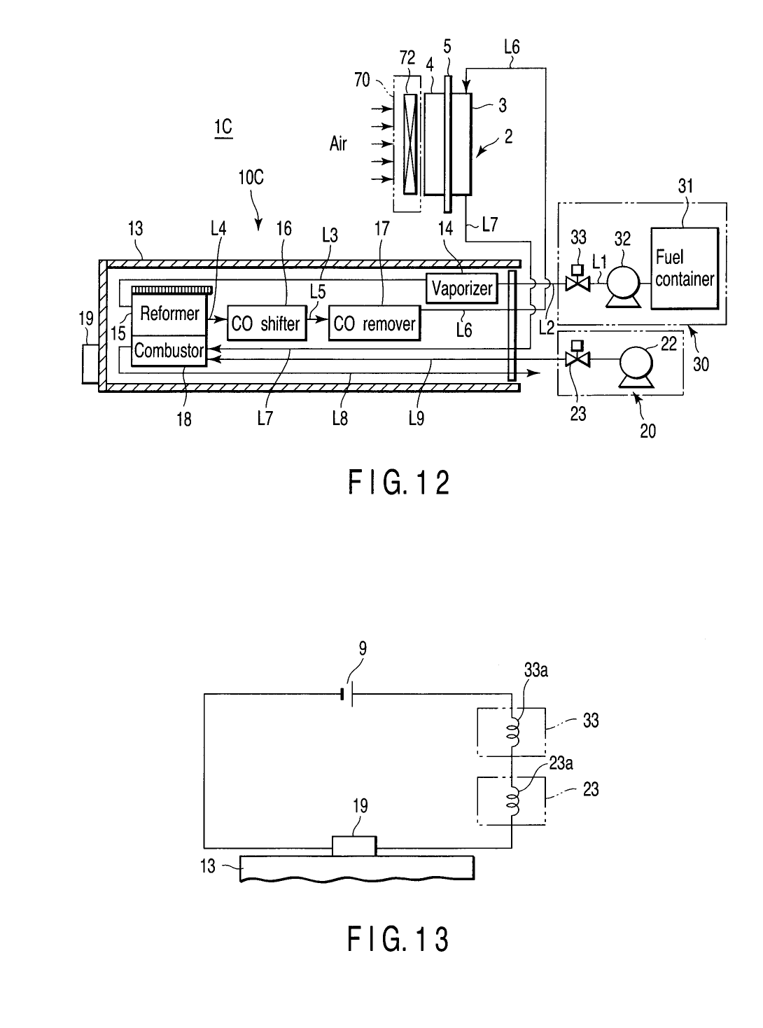

Next, a fuel cell system 1C according to a fourth embodiment will be described by referring to FIGS. 12 to 14. The part of description in the present embodiment overlapping that of the first to third embodiments will be omitted.

In the fuel cell system 1C of the present embodiment, opening and closing operations of a first stop valve 33 in a fuel supply section 30 and a second stop valve 23 of an oxidant supply section 20 are ON/OFF-controlled by means of switching operations of a heat-sensitive switch 19, whereby the supply of a liquid fuel and an oxidant is controlled.

Namely, as shown in FIG. 12, the fuel supply section 30 is provided with a fuel stop valve 33, while the oxidant supply section 20 is provided with an oxidant stop valve 23. Both the stop valves 33 and 23 are electromagnetic valves, respectively. Both the stop valves 33 and 23 are opened in case of the steady operation of the fuel cell system 1C, but when an electric current flows through armature coils 33a and 23a, they are closed, i.e., they are so-called latching valves of a normally open type.

As shown in FIG. 13, the armature coil 33a of the fuel stop valve 33 and the armature coil 23a of the oxidant stop valve 23 are connected to a power source 9 through the heat-sensitive switch 19. In other words, the heat-sensitive switch 19 is serially connected to the armature coils 33a and 23a with respect to the power source 9. Here, a normally OFF type switch such as a bimetal switch is used for the heat-sensitive switch 19. The bimetal switch is the one for conducting ON/OFF operations by utilizing thermal deformation of the bimetal, and is usually composed of a movable terminal made of a bimetal and a fixed contact. Although the movable terminal is normally in contact with the fixed contact, when a temperature rises, the bimetal deforms thermally, whereby the movable contact is apart from the fixed contact so that the bimetal switch comes to be in the OFF condition.

In the case where such bimetal switch is used as the heat-sensitive switch 19, when a temperature of the outer wall 13c of a heat insulation container 13 exceeds the set value, the heat-sensitive switch 19 becomes the ON condition. When the heat-sensitive switch 19 is in the ON condition, an electric current is fed to the armature coils 33a and 23a from the power source 9. As a result, the fuel stop valve 33 is closed, whereby supply of a fuel from the fuel supply section 30 to a reformer 15 is stopped. Furthermore, when the oxidant stop valve 23 is closed, supply of an oxidant from the oxidant supply section 20 to a combustor 18 is also stopped. Thus, the reforming reaction in the reformer 15 and the oxidizing combustion reaction in the combustor 18 do not proceed, whereby it becomes possible to prevent an abnormal temperature rise (overheating) of the outer wall 13c of the heat insulation container 13.

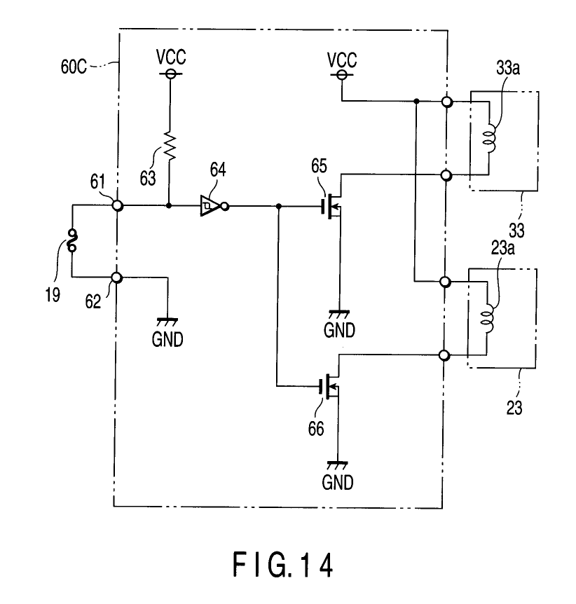

FIG. 14 illustrates a modification of the present embodiment and the same drive circuit 60C as the drive circuit 60A shown in FIG. 10 is used. However, the heat-sensitive switch 19 of a normally ON type switch such as a thermal fuse is replaced by a normally OFF type switch such as a bimetal switch. The drain terminals of transistors 65 and 66 are connected to each one end of armature coils 33a and 23a. The source terminal of the transistor 65 is connected to the ground GND. The other ends of the armature coils 33a and 23a are connected to a power supply VCC. A fuel cell unit 2 may be used for the power supply VCC as in the case of the power source 9 shown in FIG. 3, or an external power supply such as a secondary battery or the other fuel cell unit may be used for the power supply VCC.

Since the heat-sensitive switch 19 is in the OFF condition in the steady state, a control terminal 61 is in a H-level, while an output of an inverter 64 becomes a L-level, and the transistors 65 and 66 are in the OFF condition. Accordingly, the feed of an electric current to the armature coils 33a and 23a is shut off, so that stop valves 33 and 23 are opened together.

On the other hand, when a temperature of an outer wall exceeds the set value due to, for example, a damage of a heat insulation container 13 so that the heat-sensitive switch 19 becomes the ON condition, an electric potential of the control terminal 61 is in a L-level, while that of the gate terminals of the transistors 65 and 66 are in a H-level, whereby both the transistors 65 and 66 become the ON condition. Thus, an electric current is fed to the armature coils 33a and 23a, so that both of the stop valves 33 and 23 are closed. Therefore, supply of a liquid fuel to the reformer 15 and supply of an oxidant (air) to the combustor 18 are stopped.

According to the present invention, there can be provided a safe and highly reliable fuel reforming apparatus and a fuel cell system, having a compact and simple construction, which can cope with an accident such as a breakage of a heat insulation container and the like or an abnormal condition arising accidentally.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel reforming apparatus, comprising:
a reformer to reform a liquid fuel to produce a hydrogen-containing gas;
a combustor to burn hydrogen with an oxidant to obtain a combustion heat used for heating the reformer;
a heat insulation container which surrounds the reformer and the combustor;
a heat-sensitive switch which conducts switching operations, when a temperature of an outer wall of the heat insulation container exceeds a set value;
a fuel supply section which has a first electrical driving section that receives feed of an electric current from a power source through the heat-sensitive switch, and which supplies the liquid fuel to the reformer during a period in which the temperature is equal to or less than the set value; and
an oxidant supply section which supplies the oxidant to the combustor.

2. The fuel reforming apparatus according to claim 1, wherein the heat-sensitive switch is configured such that an ON condition is turned to an OFF condition when the temperature exceeds the set value; and the first electrical driving section comprises a first pump operating to discharge the liquid fuel when the electric current is fed from the power source through the heat-sensitive switch.

3. The fuel reforming apparatus according to claim 1, wherein the heat-sensitive switch is configured such that an OFF condition is turned to an ON condition when the temperature exceeds the set value; and the first electrical driving section includes a first stop valve which opens to supply the liquid fuel to the reformer in the steady state and which closes when an electric current is fed from the power source through the heat-sensitive switch.

4. The fuel reforming apparatus according to claim 1, wherein the oxidant supply section has a second electrical driving section operated by receiving feed of an electric current from the power source through the heat-sensitive switch, and supplies the oxidant to the combustor during a period in which the temperature is equal to or less than the set value.

5. The fuel reforming apparatus according to claim 4, wherein the heat-sensitive switch is configured such that an ON condition is turned to an OFF condition when the temperature exceeds the set value; and the second electrical driving section comprises a second pump operating to discharge the oxidant when the electric current is fed from the power source through the heat-sensitive switch.

6. The fuel reforming apparatus according to claim 4, wherein the second electrical driving section comprises a second stop valve which opens to supply the oxidant to the combustor in the steady state and which closes when an electric current is fed from the power source through the heat-sensitive switch.

7. The fuel reforming apparatus according to claim 1, wherein the heat-sensitive switch is any one member selected from a PTC thermistor, an NTC thermistor, a thermal fuse, a bimetal switching device, and a magnetic material switching device.

8. The fuel reforming apparatus according to claim 1, further comprising: a CO shifter to shift and change carbon monoxide in the hydrogen-containing gas to carbon dioxide in accordance with shift reaction; and a CO remover to remove carbon monoxide from the hydrogen-containing gas in accordance with methanation reaction.

9. A fuel reforming apparatus, comprising:
a reformer to reform a liquid fuel to produce a hydrogen-containing gas;
a combustor to burn hydrogen with an oxidant to obtain a combustion heat used for heating the reformer;
a heat insulation container which surrounds the reformer and the combustor;
a heat-sensitive switch which conducts switching operations when a temperature of an outer wall of the heat insulation container exceeds a set value;
an electric current production section which produces electric current turned ON/OFF by switching the operations of the heat-sensitive switch;
a fuel supply section which has a first electrical driving section operated by receiving feed of an electric current from the electric current production section, and which supplies the liquid fuel to the reformer during a period in which the temperature is equal to or less than the set value; and
an oxidant supply section which supplies the oxidant to the combustor.

10. The fuel reforming apparatus according to claim 9, wherein an one end of the heat-sensitive switch is connected to a point of a first electrical potential; the electric current production section includes a control terminal connected to another end of the heat-sensitive switch, and a pull-up resistor an one end of which is connected to the control terminal, while another end thereof is connected to a point of a second electrical potential; and the electric current is produced in accordance with a change in the electrical potential of the control terminal.

11. The fuel reforming apparatus according to claim 9, wherein the electric current production section is configured to produce the electric current during a period in which the temperature is equal to or less than the set value; and the first electrical driving section includes a first pump operating to discharge the liquid fuel by receiving feed of the electric current.

12. The fuel reforming apparatus according to claim 9, wherein the electric current production section is configured to produce the electric current when the temperature exceeds the set value; and the first electrical driving section comprises a first stop valve which opens to supply the liquid fuel to the reformer in the steady state and which closes when the electric current is fed.

13. The fuel reforming apparatus according to claim 9, wherein the oxidant supply section has a second electrical driving section operated by receiving feed of the electric current, and supplies the oxidant to the combustor during a period in which the temperature is equal to or less than the set value.

14. The fuel reforming apparatus according to claim 13, wherein the electric current production section is configured to produce the electric current during a period in which the temperature is equal to or less than the set value; and the second electrical driving section comprises a second pump operating to discharge the oxidant by receiving feed of the electric current.

15. The fuel reforming apparatus according to claim 9, wherein the heat-sensitive switch is any one member selected from a PTC thermistor, an NTC thermistor, a thermal fuse, a bimetal switching device, and a magnetic material switching device.

16. The fuel reforming apparatus according to claim 9, further comprising: a CO shifter to shift and change carbon monoxide in the hydrogen-containing gas to carbon dioxide in accordance with shift reaction; and a CO remover to remove carbon monoxide from the hydrogen-containing gas in accordance with methanation reaction.

17. A fuel cell system, comprising:
a reformer to reform a liquid fuel to produce a hydrogen-containing gas;
a combustor to burn hydrogen with an oxidant to obtain a combustion heat used for heating the reformer;
a heat insulation container which surrounds the reformer and the combustor;
a heat-sensitive switch which conducts switching operations when a temperature of an outer wall of the heat insulation container exceeds a set value;
an electric current production section which produces electric current turned ON/OFF by the switching operations of the heat-sensitive switch;
a fuel supply section which has a first electrical driving section operated by receiving feed of an electric current from the electric current production section, and which supplies the liquid fuel to the reformer during a period in which the temperature is equal to or less than the set value;
an oxidant supply section which supplies the oxidant to the combustor; and
a fuel cell unit having an anode electrode which receives the hydrogen-containing gas produced by the reformer, a cathode electrode, and an electrolyte membrane.

18. The fuel cell system according to claim 17, wherein the combustor of the fuel reforming apparatus burns hydrogen contained in exhaust gas from the anode electrode with the oxidant.

19. The fuel cell system according to claim 17, further comprising an air supply section which supplies air to the cathode electrode.

20. The fuel cell system according to claim 19, wherein the air supply section has a third electrical driving section operating by receiving feed of the electric current produced in the electric current production section, and
the electric current production section further comprises a timer circuit which produces the electric current during a period in which the temperature is equal to or less than the set value, and which stops the production of the electric current fed to the third electrical driving section after the elapse of a predetermined period of time from the time of the previous switching operation.
